(19) United States
(12) Patent Application Publication
(10) Pub. No.: US 2026/0257794 A1
(43) Pub. Date: Sep. 3, 2026

(54) Enhanced Aircraft Black Box System with Automatic Jettison and Deployment Mechanism

(71) Applicant: Travis Ryan Henderson, Spokane, WA (US)

(72) Inventor: Travis Ryan Henderson, Spokane, WA (US)

(21) Appl. No.: 19/457,845

(22) Filed: Jan. 23, 2026

Related U.S. Application Data
(60) Provisional application No. 63/752,802, filed on Feb. 2, 2025.

(51) Int. Cl. B64D 1/12; B64D 45/00

(52) U.S. Cl. CPC B64D 1/12; B64D 2045/0065

(57) ABSTRACT

The present disclosure relates to an enhanced aircraft flight data recording system that improves data recovery in the event of an accident. Traditional black boxes, including the cockpit voice recorder (CVR) and flight data recorder (FDR), are often difficult to locate or recover after a crash. This invention introduces multiple or redundant recorders equipped with an automatic jettison mechanism that deploys prior to impact. The system utilizes sensors and predictive algorithms to detect imminent crashes, triggering the release of one or more recorders through explosive charges or auto-opening panels. Jettisoned recorders are outfitted with parachutes for controlled descent and enclosed in a protective, floatable casing to ensure recovery. Additionally, the system transmits real-time distress signals with GPS coordinates upon ejection, aiding in rapid retrieval. This system significantly enhances aircraft safety by increasing the likelihood of successful black box recovery, reducing search efforts, and improving accident investigation efficiency.

### BACKGROUND

Current commercial and military aircraft utilize two primary types of flight data recording devices: the cockpit voice recorder (CVR) and the flight data recorder (FDR). These devices are typically housed in the aircraft's tail section and are designed to withstand severe impact forces, fire, and water submersion. However, in many cases of catastrophic failure, the black boxes may be difficult to locate or may sustain damage that renders them unreadable.

### SUMMARY

The present disclosure is directed to systems and methods for an enhanced aircraft black box system. The disclosed techniques address limitations in data recovery by physically separating the recorder from the aircraft prior to impact. In aspects, a flight data recording system includes at least one primary recorder and at least one auxiliary recorder, one of which is configured to automatically eject from the aircraft upon detection of imminent impact. This automatic jettison mechanism may employ a small explosive charge to forcibly eject the recorder or utilize an auto-opening panel that releases the unit upon detection of imminent impact with water or ground.

The system may further include multiple auxiliary recorders deployed at different strategic locations within the aircraft, such as the dorsal section for upward ejection or the belly for passive separation. To ensure safe delivery of the data, each jettisoned recorder is outfitted with a parachute system that deploys upon ejection to slow descent. The recorder casing is designed to be fire-resistant, waterproof, and capable of floating on water, ensuring the integrity of recorded data in extreme environments. Furthermore, the casing may include a self-righting mechanism for stability in water and an aerodynamic housing for controlled descent. In some implementations, the auxiliary recorder system is configured as a retrofit module compatible with existing cockpit voice recorder (CVR) and flight data recorder (FDR) installations, requiring little to no modification to primary flight recording systems.

In example implementations, the system utilizes an impact prediction algorithm that determines imminent impact based on aircraft telemetry data. The jettison mechanism is activated when the aircraft is detected to be within a predetermined range of unintended impact and is configured to operate under extreme temperature and pressure conditions. Upon ejection, the recorder activates a real-time emergency signal transmitter that broadcasts global positioning system (GPS) coordinates and is satellite-compatible. The recorder may also include redundant power sources to ensure continued operation post-ejection and a visual indicator to aid in manual retrieval.

### BRIEF DESCRIPTION OF DRAWINGS

Apparatuses of and techniques for an enhanced aircraft black box system are described with reference to the following drawings. The same numbers are used throughout the drawings to reference like features and components.

FIG. 1 illustrates an example operating environment in which techniques for an enhanced aircraft black box system can be implemented.

FIG. 2 illustrates an isometric view of a jettisonable recorder unit for an enhanced aircraft black box system.

FIG. 3 illustrates a cross-sectional view of a jettison mechanism for an enhanced aircraft black box system.

FIG. 4 illustrates an example implementation of a jettisonable recorder unit for an enhanced aircraft black box system.

FIG. 5 illustrates an example block diagram in which techniques for an enhanced aircraft black box system can be implemented.

FIG. 6 illustrates another example implementation of a jettisonable recorder unit for an enhanced aircraft black box system.

### DETAILED DESCRIPTION

### Overview

This document describes an enhanced aircraft black box system that improves data recovery in the event of an accident. Conventional black boxes are often limited by their fixed position within the airframe, which subjects them to the full force of impact. The present disclosure utilizes a network of primary and auxiliary recorders, each designed to capture and store critical flight and cockpit data. The system integrates impact prediction algorithms that use aircraft sensors and flight control systems to predict catastrophic failures or unintended ground/water impact with high accuracy. Existing solutions rely heavily on the structural integrity of the box itself rather than avoidance of the impact zone. These limitations often result in prolonged search and recovery efforts, sometimes leaving the cause of an accident undetermined.

Some features of the apparatus may include a jettison mechanism that combines high-speed actuators, explosive separation bolts, and aerodynamic launching systems to ensure successful deployment. In some implementations, the jettison mechanism includes non-pyrotechnic release mechanisms configured to comply with aircraft certification requirements. The method of jettison is adaptable based on aircraft type and mission profile. Upon separation, a parachute housed within the protective casing deploys automatically, controlling descent speed and reducing ground impact forces. The protective casing is reinforced with heat-resistant materials and buoyant components, allowing the device to remain afloat and withstand extreme environmental exposure.

To ensure rapid location and recovery, the recorder activates a distress beacon upon ejection. This beacon can transmit real-time GPS coordinates and system identifiers to aviation authorities, emergency responders, and search teams. The system significantly enhances aircraft safety by increasing the likelihood of successful black box recovery, reducing search efforts, and improving accident investigation efficiency. Additionally, the system minimizes structural impact on the aircraft, integrating seamlessly with existing structures without significant weight or aerodynamic penalties. In some implementations, the recorder transmits encrypted flight data to a remote server for real-time or post-event analysis.

### Example Operating Environment

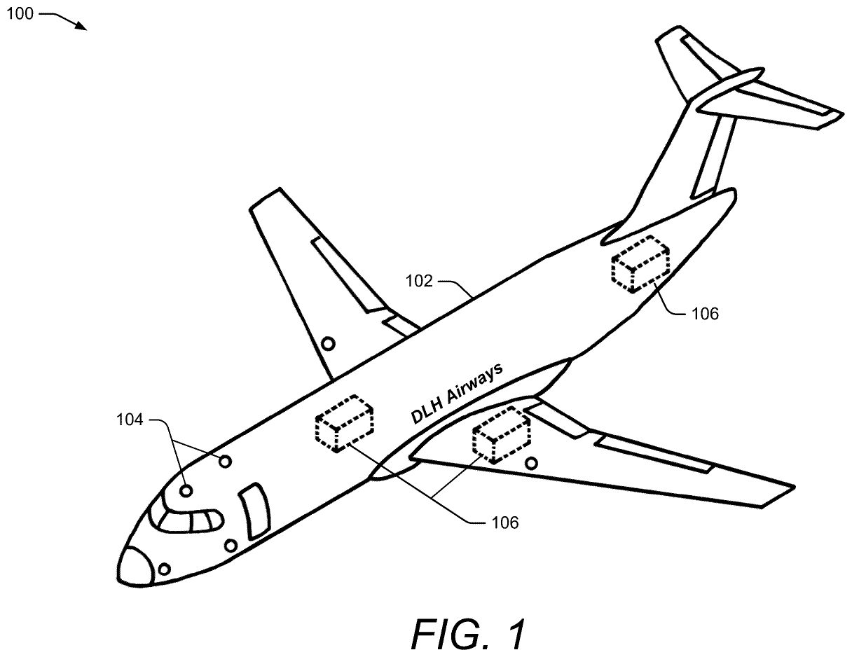

FIG. 1 illustrates an example operating environment 100 for an enhanced aircraft black box system. The environment 100 includes an aircraft 102 designed to transport passengers or cargo. To ensure data preservation during catastrophic events, the aircraft 102 may be equipped with one or more sensors 104, such as altimeters, accelerometers, or structural integrity monitors, located in the nose or avionics bay. The one or more sensors 104 may communicate with one or more auxiliary jettisonable recorder units 106 distributed strategically throughout the fuselage. While traditional recorders are fixed, the one or more auxiliary jettisonable recorder units 106 are configured to separate from the aircraft 102 prior to impact, with potential placements including the dorsal section for upward ejection or the belly for gravity-assisted release. This distributed placement can allow for multiple opportunities to save data; for example, if a dorsal unit is blocked by debris, a belly unit may still successfully deploy.

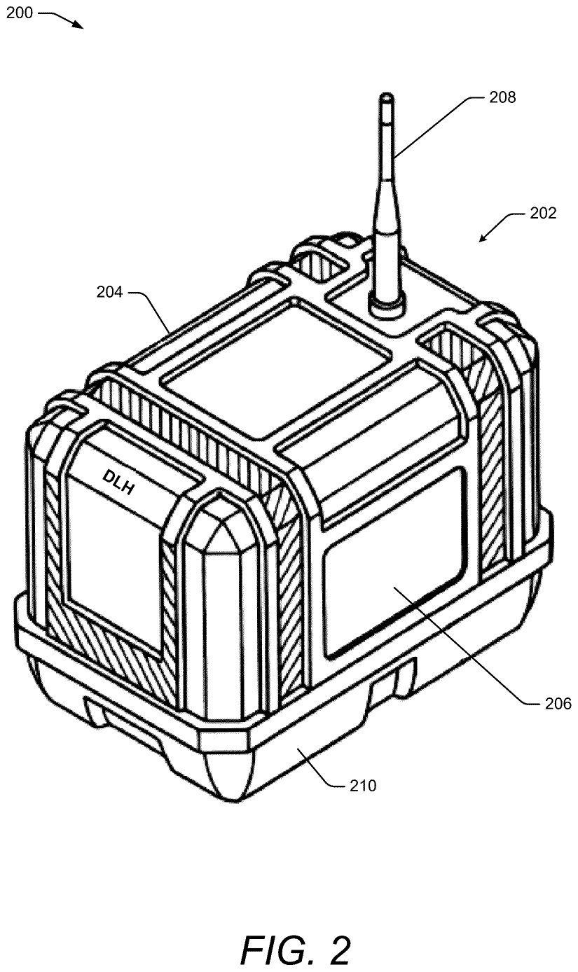

FIG. 2 illustrates an isometric view 200 of a jettisonable recorder unit 202 (e.g., one of the one or more auxiliary jettisonable recorder units 106 of FIG. 1). The jettisonable recorder unit 202 may be enclosed in a casing 204 designed to be waterproof, fireproof, and impact-resistant. The casing 204 may further feature an aerodynamic housing shape to stabilize the jettisonable recorder unit 202 during high-speed rejection and controlled descent, reducing tumbling and potential damage. Integrated into the upper portion of the jettisonable recorder unit 202 is a parachute compartment 206, which may house a deployment system to slow the descent of the jettisonable recorder unit 202. Extending from the jettisonable recorder unit 202 is a transmission antenna 208 capable of broadcasting real-time location data to satellites or ground stations. To ensure recovery in maritime accidents, the base of the jettisonable recorder unit 202 may include a flotation aid 210, such as a buoyant bumper or foam core, which can allow the jettisonable recorder unit 202 to remain on the water's surface. Additionally, the jettisonable recorder unit 202 may be equipped with a visual indicator (not illustrated), such as a high-intensity strobe light or a high-visibility dye-marker, to aid in manual retrieval by visual search teams.

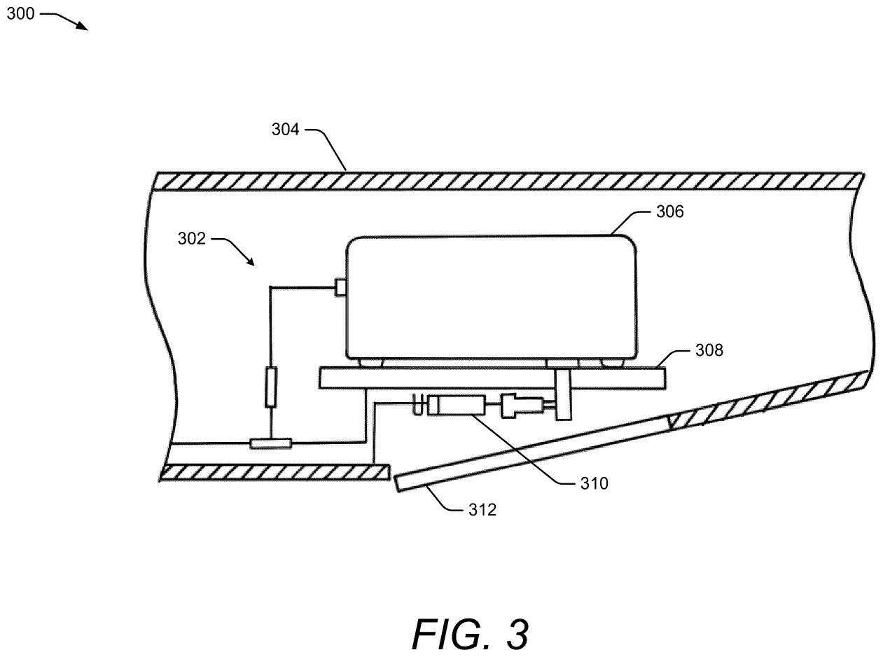

FIG. 3 illustrates a cross-sectional view 300 of a jettison mechanism 302 installed within an aircraft (e.g., the aircraft 102 of FIG. 1). The jettison mechanism 302 may be mounted within an airframe 304 of the aircraft. The jettison mechanism 302 may secure a jettisonable recorder unit 306 (e.g., the jettisonable recorder unit 202 in FIG. 2) on a mounting platform 308. To facilitate rapid separation, the jettison mechanism 302 may utilize an actuator system 310, which may include explosive separation bolts, high-speed pneumatic pistons, or spring-loaded release devices. The jettison mechanism 302 may be designed to operate reliably under extreme temperature and pressure conditions, ensuring functionality even during high-altitude incidents or post-explosion scenarios. For example, the mechanism 302 may be configured to operate in temperature ranges from −55° C. to 70° C. and pressure altitudes up to 50,000 feet or withstand transient blast pressures of 5 to 10 psi during a structural failure event. Upon activation, the actuator system 310 may drive the jettisonable recorder unit 306 through an auto-opening panel 312 located on the exterior of the aircraft, ensuring a clear exit path even under extreme structural stress.

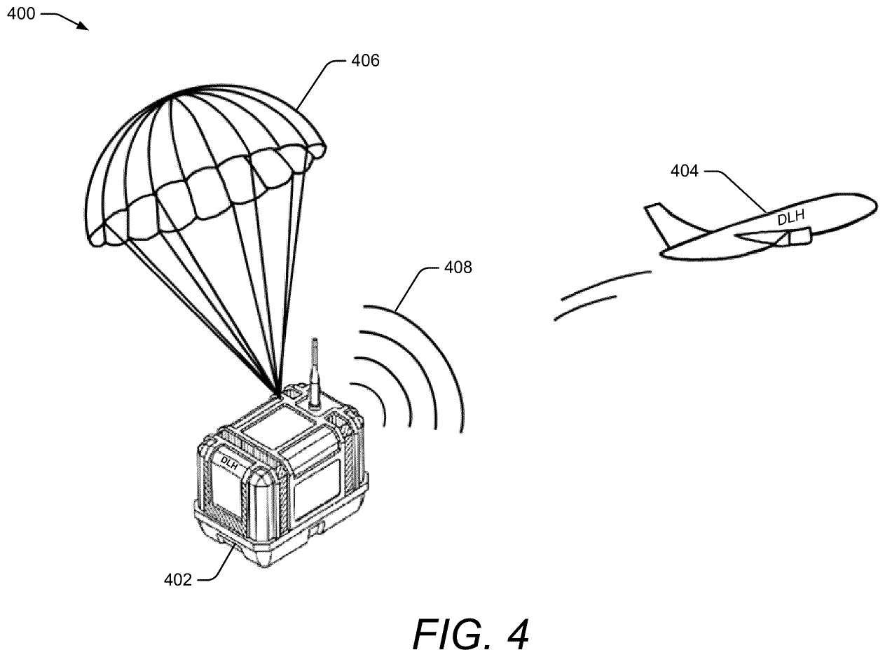

FIG. 4 illustrates an example implementation 400 of a jettisonable recorder unit 402 (e.g. the jettisonable recorder unit 202 of FIG. 2). The jettisonable recorder unit 402 may have successfully separated from a distressed aircraft 404 that is experiencing a critical failure. Immediately following separation, the jettisonable recorder unit 402 may deploy a parachute 406 to stabilize its trajectory and minimize impact forces upon landing. Simultaneously, the jettisonable recorder unit 402 may begin broadcasting emergency signals 408 via its internal transmitter. The emergency signals 408 can contain specific identification data and real-time global positioning system (GPS) coordinates, allowing search and rescue teams to track the location of the jettisonable recorder unit 402 while it is still airborne or immediately upon landing. The emergency signals 408 ensure that location data is relayed even in remote oceanic or polar regions.

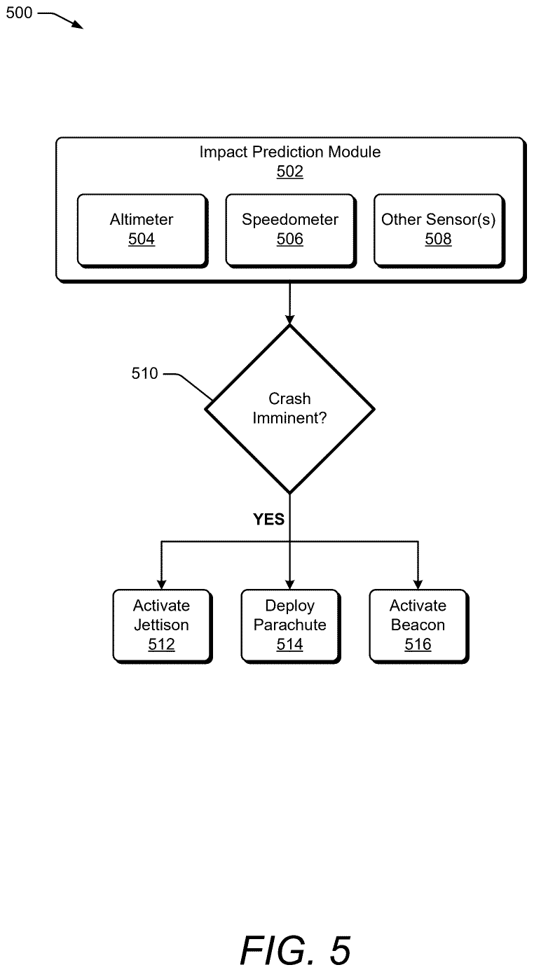

FIG. 5 illustrates a block diagram 500 for an automatic deployment system. The central processing component is the impact prediction module 502, which aggregates and analyzes flight telemetry. Data inputs can be provided by an altimeter 504, a speedometer 506, and one or more other sensors 508 (such as g-force sensors or attitude indicators). The impact prediction module 502 can process this data to execute a decision step 510, determining if a crash is imminent based on parameters like rapid altitude loss or loss of control. In some implementations, the automatic deployment system may determine imminent impact when an aircraft is detected to be within a predetermined range of unintended impact. The automatic deployment system may further include a deployment controller (not illustrated) responsive to the impact prediction module 502. The deployment controller may be configured to initiate at least one protective data-preservation action prior to unintended impact. These actions are selected from a group including, but not limited to, (i) separating at least one of the flight data recorders from the aircraft; (ii) activating an emergency transmission of recorded data or location information; (iii) enabling a survivability mode of the recorder (e.g., locking data to prevent overwrite or engaging additional hardening measures); or (iv) deploying a recovery aid associated with the recorder. These actions may be initiated based on a predicted imminent impact event occurring prior to physical contact with terrain or water.

If the decision step 510 yields an affirmative result, the automatic deployment system can trigger three simultaneous or sequential actions: activate jettison 512 (triggering the actuators), deploy parachute 514 (releasing the canopy), and activate beacon 516 (transmitting the distress signal). The impact prediction module 502 may dynamically adjust deployment thresholds based on aircraft phase of flight, environmental conditions, or historical sensor data. Further, the impact prediction module 502 may operate independently of the jettison mechanism, enabling deployment of location and transmission features without physical separation. To ensure reliability, a jettisonable recorder unit may include redundant power sources, such as backup batteries or capacitors, to allow for continued operation post-ejection and beacon transmission for an extended period.

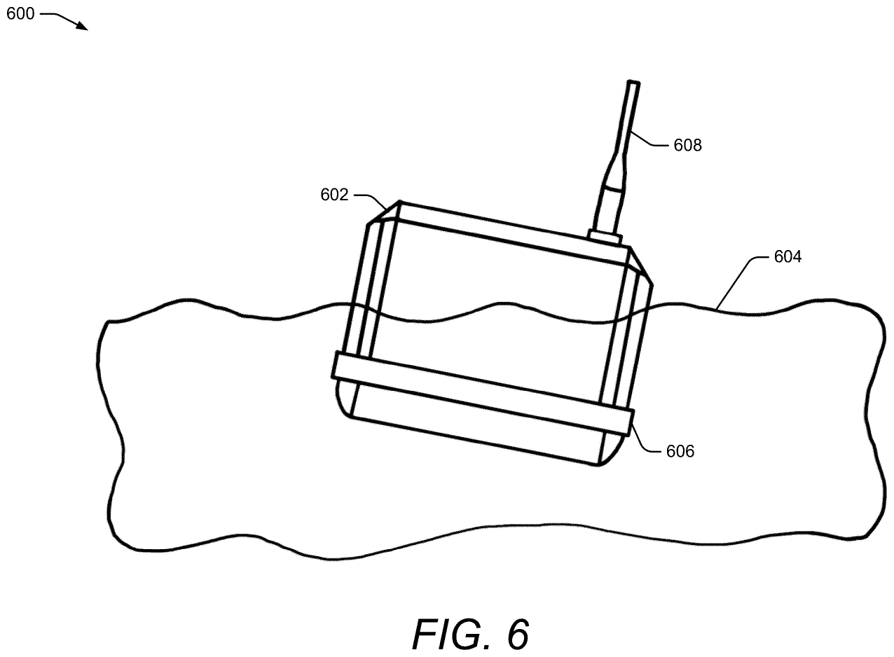

FIG. 6 illustrates an example implementation 600 of a jettisonable recorder unit 602 floating in a body of water 604 following a water landing. A casing 606 of the jettisonable recorder unit 602 may be sealed to prevent water ingress and protect the internal data storage. The jettisonable recorder unit 602 may be balanced via a self-righting mechanism (e.g., a weighted ballast in the base) such that a transmission antenna 608 remains oriented above the water line of the body of water 604, ensuring continuous signal transmission to recovery crews.

### EXAMPLES

Various examples are described herein, including a flight data recording system (example 1), which includes at least one primary recorder and at least one auxiliary recorder configured to automatically eject from the aircraft upon detection of imminent impact.

Example 2: The system of example 1, where the auxiliary recorder is ejected using a small explosive charge.

Example 3: The system of example 1, where the auxiliary recorder is released through an auto-opening panel.

Example 4: The system of example 1 further includes a parachute system that deploys upon recorder ejection.

Example 5: The system of example 1, where the recorder casing is designed to float on water.

Example 6: The system of example 1, where the recorder casing is fire-resistant and waterproof.

Example 7: The system of example 1 further includes an impact prediction algorithm that determines imminent impact based on aircraft telemetry data.

Example 8: The system of example 1 further includes a real-time emergency signal transmitter.

Example 9: The system of example 8, where the emergency signal includes GPS coordinates.

Example 10: A flight data recording system for aircraft, where the jettison mechanism is activated when the aircraft is detected to be within a predetermined range of unintended impact.

Example 11: The system of example 10 further includes multiple auxiliary recorder units deployed at different locations within the aircraft.

Example 12: The system of example 10, where the jettison mechanism is configured to operate under extreme temperature and pressure conditions.

Example 13: The system of example 10 further includes a self-righting mechanism for stability in water.

Example 14: A flight data recording system, wherein the recorder's emergency beacon is satellite-compatible and transmits a distress signal upon ejection.

Example 15: The system of example 14 further includes an aerodynamic housing for controlled descent.

Example 16: The system of example 14, where the recorder includes redundant power sources to ensure continued operation post-ejection.

Example 17: The system of example 14 further includes a visual indicator to aid in manual retrieval of the recorder.

Example 18: A flight data preservation system for an aircraft, including: one or more flight data recorders configured to record operational or cockpit data during flight; an impact prediction module operatively coupled to one or more aircraft sensors, the impact prediction module configured to analyze real-time flight telemetry and determine a likelihood of unintended impact; and a deployment controller responsive to the impact prediction module and configured, prior to the unintended impact, to initiate at least one protective data-preservation action selected from the group of: (i) separating at least one of the flight data recorders from the aircraft; (ii) activating an emergency transmission of recorded data or location information; (iii) enabling a survivability mode of the recorder; or (iv) deploying a recovery aid associated with the recorder, where the protective data-preservation action is initiated based on a predicted imminent impact event occurring prior to physical contact with terrain or water.

### Conclusion

Unless context dictates otherwise, use herein of the word “or” may be considered use of an “inclusive-or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c or any other ordering of a, b, and c). Further, items represented in the accompanying figures and terms discussed herein may be indicative of one or more items or terms, and thus reference may be made interchangeably to single or plural forms of the items and terms in this written description.

Although concepts of an enhanced aircraft black box system have been described in language specific to techniques and/or systems, it is to be understood that the subject of the appended claims is not necessarily limited to the specific techniques or methods described. Rather, the specific techniques and methods are disclosed as example implementations for an enhanced aircraft black box system.

What is claimed is:

1. A flight data recording system for aircraft, comprising at least one primary recorder and at least one auxiliary recorder, the at least one auxiliary recorder configured to automatically eject from the aircraft upon detection of imminent impact.

2. The system of claim 1, wherein the auxiliary recorder is configured to be ejected using a small explosive charge.

3. The system of claim 1, wherein the auxiliary recorder is configured to be released through an auto-opening panel.

4. The system of claim 1, further comprising a parachute system attached to the at least one auxiliary recorder, the parachute system configured to deploy upon recorder ejection.

5. The system of claim 1, further comprising a recorder casing configured to float on water, the recording casing comprising the at least one auxiliary recorder.

6. The system of claim 5, wherein the recorder casing is fire-resistant and waterproof.

7. The system of claim 1, further comprising an impact prediction algorithm, the impact prediction algorithm configured to determine imminent impact based on aircraft telemetry data.

8. The system of claim 1, further comprising a real-time emergency signal transmitter.

9. The system of claim 8, wherein the real-time emergency signal includes GPS coordinates.

10. A flight data recording system for an aircraft having a jettison mechanism, the jettison mechanism configured to be activated when the aircraft is detected to be within a predetermined range of unintended impact.

11. The flight data recording system of claim 10, further comprising multiple auxiliary recorders configured to be deployed at different locations within the aircraft.

12. The flight data recording system of claim 10, wherein the jettison mechanism is configured to operate under extreme temperature and pressure conditions.

13. The flight data recording system of claim 10, further comprising a self-righting mechanism for stability in water.

14. A flight data recording system, having an emergency beacon, the emergency beacon configured to be satellite-compatible and transmit to a satellite-receivable distress signal upon ejection.

15. The flight data recording system of claim 14, further comprising an aerodynamic housing for controlled descent.

16. The flight data recording system of claim 14, wherein a recorder of the flight data recording system includes redundant power sources.

17. The flight data recording system of claim 14, further comprising a visual indicator to aid in manual retrieval of the recorder.

18. A flight data preservation system for an aircraft, comprising:
one or more flight data recorders configured to record operational or cockpit data during flight;
an impact prediction module operatively coupled to one or more aircraft sensors, the impact prediction module configured to analyze real-time flight telemetry and determine a likelihood of unintended impact; and
a deployment controller responsive to the impact prediction module and configured, prior to the unintended impact, to initiate at least one protective data-preservation action selected from the group consisting of:
(i) separating at least one of the flight data recorders from the aircraft;
(ii) activating an emergency transmission of recorded data or location information;
(iii) enabling a survivability mode of the recorder; or
(iv) deploying a recovery aid associated with the recorder, wherein the protective data-preservation action is initiated based on a predicted imminent impact event occurring prior to physical contact with terrain or water.
